(19) United States
(12) Patent Application Publication
(10) Pub. No.: US 2018/0201072 A1
(43) Pub. Date: Jul. 19, 2018

(54) Pneumatic Tire

(71) Applicant: The Yokohama Rubber Co., LTD., Tokyo (JP)

(72) Inventor: Mina Fukuda, Hiratsuka-shi (JP)

(73) Assignee: The Yokohama Rubber Co., LTD.

(21) Appl. No.: 15/871,772

(22) Filed: Jan. 15, 2018

(30) Foreign Application Priority Data
Jan. 16, 2017 (JP) 2017-005004

(51) Int. Cl. B60C 11/04

(52) U.S. Cl. CPC B60C 11/047; B60C 2011/1361

(57) ABSTRACT

A tread surface of a tread portion of a pneumatic tire comprises a circumferential main groove and a projection body extending continuously in a tire circumferential direction, the projection body projecting in a tire radial direction from a groove bottom of the circumferential main groove; and connecting portions connecting the projection body and groove walls of the circumferential main groove alternately disposed in the tire circumferential direction on first and second sides of the projection body in a tire lateral direction; a relationship of L to a total of V₁ to Vₙ and W₁ to Wₙ satisfying from 0.7 L to 1.5 L, where L is a circumferential length of the projection body, and V₁ to Vₙ and W₁ to Wₙ are circumferential dimensions of the connecting portions on the first and second sides of the projection body in the tire lateral direction, respectively.

### PRIORITY CLAIM

Priority is claimed to Japan Patent Application Serial No. 2017-005004 filed on Jan. 16, 2017.

### TECHNICAL FIELD

The present technology relates to a pneumatic tire.

### BACKGROUND ART

There is a demand for tires for on-road and off-road driving that can prevent stones from getting trapped in circumferential main grooves (stone entrapment). When stones lodged in the groove reach the groove bottom, stone drilling may occur causing cracking in the groove bottom and damage to belts, which forms the internal structure of the tread portion. This can reduce durability and reduce retread rate. Thus, in recent years, pneumatic tires (particularly heavy duty pneumatic tires) have been designed to reduce stone entrapment and improve anti-stone drilling performance by being provided with a projection portion (stone ejector) in the groove bottom portion of the circumferential main grooves.

In the related art, for example, the pneumatic tire described in Japanese Patent No. 4918842 includes a tread portion including a plurality of circumferential main grooves extending in the tire circumferential direction; a plurality of land portions defined by the plurality of circumferential main grooves; a projection portion formed in the groove bottom portion of at least one of the plurality of circumferential main grooves, the projection portion extending continuously in the groove length direction of the circumferential main groove and having a height that varies in a wave-like manner as it extends in the groove length direction; and a connecting portion connecting the projection portion to at least one of the groove wall portions of the circumferential main groove at a position where the projection portion is at the maximum height.

Also in the related art, the anti-stone entrapment tread pattern described in Japanese Unexamined Patent Application Publication No. 61-291203 includes at least two circumferential grooves extending in a zigzag manner along the circumference of the tread portion; at least one projection disposed per zigzag pitch in the groove bottoms of the circumferential grooves having a length ranging from 0.3 times to 0.8 times the zigzag pitch of the circumferential grooves; and connecting portions integrally formed with the groove wall of the circumferential groove having a height from the groove bottom of 0.5 times or greater than the height of the top surface of the projection positioned at a depth measured from the tread portion of 0.7 times or less of the groove width and a length 0.4 times or greater, the connecting portions being alternately disposed on the left and right sides for adjacent projections.

In the technology of Japanese Patent No. 4918842, the total dimensions of the connecting portion in the tire circumferential direction is not described, and by referencing FIGS. 1 and 2, it can be seen that the length is approximately 35% of the length of the projection portions in the tire circumferential direction. In a technology such as that of Japanese Patent No. 4918842, a stone may reach the groove bottom by pushing the projection portions aside and getting caught between the projection portions where a connecting portion is absent and the groove wall portion.

In the technology of Japanese Unexamined Patent Application Publication No. 61-291203, the projection is disposed on the groove bottom of the circumferential groove and has a length ranging from 0.3 to 0.8 times the length of the zigzag pitch of the circumferential groove. In other words, the projection is divided in the tire circumferential direction. In a technology such as that of Japanese Unexamined Patent Application Publication No. 61-291203, a stone may reach the groove bottom via a portion between the projections where a connecting portion is absent.

### SUMMARY

The present technology provides a pneumatic tire that can provide improved anti-stone drilling performance.

A pneumatic tire according to an aspect of the present technology comprises a tread surface of a tread portion comprising:

at least one circumferential main groove extending continuously in a tire circumferential direction;

a projection body extending continuously in the tire circumferential direction and projecting in a tire radial direction from a groove bottom of the at least one circumferential main groove; and

connecting portions alternately disposed in the tire circumferential direction on a first side and a second side of the projection body in a tire lateral direction, the connecting portions connecting the projection body and groove walls of the at least one circumferential main groove;

the relationship represented by Relationship (1) being satisfied, where L is a circumferential length of the projection body, V₁ to Vₙ are circumferential dimensions of the connecting portions disposed on the first side of the projection body in the tire lateral direction, and W₁ to Wₙ are circumferential dimensions of the connecting portions disposed on the second side of the projection body in the tire lateral direction.

$$0.7 L ≦ {\sum }_{k = 1}^{n} ( {V}_{k} + {W}_{k} ) ≦ 1.5 L \qquad ( 1 )$$

According to this pneumatic tire, the relationship represented by the Relationship (1) between the circumferential length L of the projection body and the total of the circumferential dimensions V, W of the connecting portions ranges from 0.7 L to 1.5 L. This allows the rigidity of the projection body to be appropriately set and anti-stone drilling performance to be improved. In other words, when the relationship between the circumferential length L of the projection body and the total of the circumferential dimensions V, W of the connecting portions is 0.7 L or greater, the rigidity of the projection body is appropriately set and the projection body is resistance to collapsing in the tire lateral direction, thus preventing stone entrapment. This improves anti-stone drilling performance. When the relationship between the circumferential length L of the projection body and the total of the circumferential dimensions V, W of the connecting portions is equal to or greater than 1.5 L, the connecting portion buries most of the groove bottom of the circumferential main groove. This reduces drainage performance and reduces the uneven wear resistance performance of the tread surface due to the high rigidity of the land portions defined by the circumferential main grooves. As a result, according to the pneumatic tire of an aspect of the present technology, anti-stone drilling performance can be further improved.

A pneumatic tire according to an aspect of the present technology preferably has a configuration wherein the at least one circumferential main groove provided with the projection body and the connecting portions is disposed at least on a tire equator line or closest to the tire equator line.

The circumferential main groove on the tire equator line or closest to the tire equator line bulges outward in the tire radial direction due to the crown shape of the tread surface. This makes it susceptible to stone entrapment. Thus, by providing the projection body and the connecting portions in the circumferential main groove disposed on the tire equator line or closest to the tire equator line, stone entrapment can be prevented. This allows a significant effect of improving anti-stone drilling performance to be obtained.

A pneumatic tire according to an aspect of the present technology preferably has a configuration wherein the relationship 0.5X≤V≤5X is satisfied, where V is the circumferential dimensions of a discretionary connecting portion of the connecting portions disposed on the first side of the projection body in the tire lateral direction, and X is a groove width of the at least one circumferential main groove; and

the relationship 0.5X≤W≤5X is satisfied, where W is the circumferential dimensions of a discretionary connecting portion of the connecting portions disposed on the second side of the projection body in the tire lateral direction, and X is the groove width of the at least one circumferential main groove.

According to the pneumatic tire, by the circumferential dimensions V, W of the connecting portions ranging from 0.5 times to 5 times the groove width X of the circumferential main groove, the rigidity of the connecting portion is appropriately set, and the change in the groove bottom of the circumferential main groove formed by the connecting portions is appropriately set. This allows a significant effect of improving anti-stone drilling performance to be obtained. When the circumferential dimensions V, W of the connecting portions are 0.5 times or greater than the groove width X of the circumferential main groove, the effect of improving the rigidity of the connecting portions can be obtained. When the circumferential dimensions V, W of the connecting portions are 5 times or less than the groove width X of the circumferential main groove, the change in the groove bottom of the circumferential main groove formed by the connecting portions is maintained and the same cross section continuing in the tire circumferential direction is prevented. This allows stone ejecting characteristics to be ensured.

A pneumatic tire according to an aspect of the present technology preferably has a configuration wherein

the relationship X≤P≤3X is satisfied, where P is a circumferential pitch of a discretionary adjacent pair of the connecting portions disposed on the first side of the projection body in the tire lateral direction, and X is the groove width of the at least one circumferential main groove; and

the relationship X≤Q≤3X is satisfied, where Q is a circumferential pitch of a discretionary adjacent pair of the connecting portions disposed on the second side of the projection body in the tire lateral direction, and X is the groove width of the at least one circumferential main groove.

According to the pneumatic tire, by the circumferential pitches P, Q of the connecting portions ranging from 1 times to 3 times the groove width X of the circumferential main groove, the rigidity of the projection body is appropriately set, and the change in the groove bottom of the circumferential main groove formed by the connecting portions is appropriately set. This allows a significant effect of improving anti-stone drilling performance to be obtained. When the circumferential pitches P, Q of the connecting portions are 1 times or greater than the groove width X of the circumferential main groove, the change in the groove bottom of the circumferential main groove formed by the connecting portions is maintained and the same cross section continuing in the tire circumferential direction is prevented. This allows stone ejecting characteristics to be ensured. When the circumferential pitches P, Q of the connecting portions are 3 times or less than the groove width X of the circumferential main groove, an effect of improving the rigidity of the projection body can be obtained.

A pneumatic tire according to an aspect of the present technology preferably has a configuration wherein the relationship 0.05H≤h≤0.5H is satisfied, where H is a groove depth of the at least one circumferential main groove and h is a height of the projection body.

According to the pneumatic tire, by specifying the height h of the projection body in relation to the groove depth H of the circumferential main groove, a significant effect of improving anti-stone drilling performance can be obtained. By the height h of the projection body being 0.05 times or greater the groove depth H of the circumferential main groove, a significant effect of preventing stone entrapment can be obtained. By the height h of the projection body being 0.5 time or less the groove depth H of the circumferential main groove, the projection body is resistant to collapsing in the tire lateral direction when stones are trapped.

A pneumatic tire according to an aspect of the present technology preferably has a configuration wherein the connecting portions are inclined outward in the tire radial direction with respect to the tire lateral direction from the projection body toward the groove walls of the at least one circumferential main groove and have an inclination angle ranging from 15° to 45°.

According to the pneumatic tire, by specifying the inclination angle of the connecting portions, stones can be prevented from being trapped in the circumferential main grooves and stone ejecting characteristics are improved. As a result, a significant effect of improving anti-stone drilling performance can be obtained. When the inclination angle of the connecting portions is 15° or greater, stones can be prevented from being caught above the connecting portions and stone entrapment can be suppressed. When the inclination angle of the connecting portions is 45° or less, a force for pushing the stone outside (toward the opening) of the circumferential main groove 15 rather than a force for drawing the stone to the groove wall 15b opposite to the connecting portion 32 works. This allows stone ejecting characteristics to be improved.

According to an aspect of the present technology, anti-stone drilling performance can be further improved.

### BRIEF DESCRIPTION OF DRAWINGS

FIG. 1 is a meridian cross-sectional view of a pneumatic tire according to an embodiment of the present technology.

FIG. 2 is a plan view of a pneumatic tire according to an embodiment of the present technology.

FIG. 3 is an enlarged cross-sectional view taken along line A-A illustrated in FIG. 2.

FIG. 4 is an enlarged cross-sectional view taken along line B-B illustrated in FIG. 2.

FIG. 5 is an enlarged cross-sectional view taken along line B-B of FIG. 2 of another embodiment.

FIG. 6 is an enlarged cross-sectional view taken along line B-B of FIG. 2 of another embodiment.

FIGS. 7A-7B include a table showing the results of performance tests of pneumatic tires according to Examples of the present technology.

FIGS. 8A-8B include a table showing the results of performance tests of pneumatic tires according to Examples of the present technology.

### DETAILED DESCRIPTION

Embodiments of the present technology will be described with reference to the drawings. However, the present technology is not limited to those embodiments. Additionally, constituents described in the embodiments described below can be combined, and some of the constituents can not be used.

Herein, “tire lateral direction” refers to a direction that is parallel with a tire rotation axis of a pneumatic tire. “Inward in the tire lateral direction” refers to a direction toward a tire equatorial plane in the tire lateral direction. “Outward in the tire lateral direction” refers to a direction away from the tire equatorial plane in the tire lateral direction. Furthermore, “tire radial direction” refers to the direction orthogonal to the tire rotation axis. “Inward in the tire radial direction” refers to the direction toward the tire rotation axis in the tire radial direction. “Outward in the tire radial direction” refers to the direction away from the tire rotation axis in the tire radial direction. “Tire circumferential direction” refers to the direction of rotation about the tire rotation axis.

“Tire equatorial plane” refers to the plane orthogonal to the tire rotation axis of the pneumatic tire that passes through the center in the tire lateral direction and refers to the centerline where the tire equatorial plane intersects the surface of the tread portion of the pneumatic tire. In the present embodiment, the tire equatorial plane and the tire equator line are denoted by the same reference sign CL.

A pneumatic tire 1 according to the present embodiment is a tubeless tire. Additionally, the pneumatic tire 1 according to the present embodiment is a heavy duty pneumatic tire mountable on a truck or bus. “Tire (heavy duty pneumatic tire) for a truck or bus” refers to a tire defined according to the chapter C of the JATMA Year Book (standards of The Japan Automobile Tyre Manufacturers Association, Inc.) published by the Japan Automobile Tyre Manufacturers Association, Inc. (JATMA). Note that the pneumatic tire 1 can be mounted on a passenger vehicle or on a light truck.

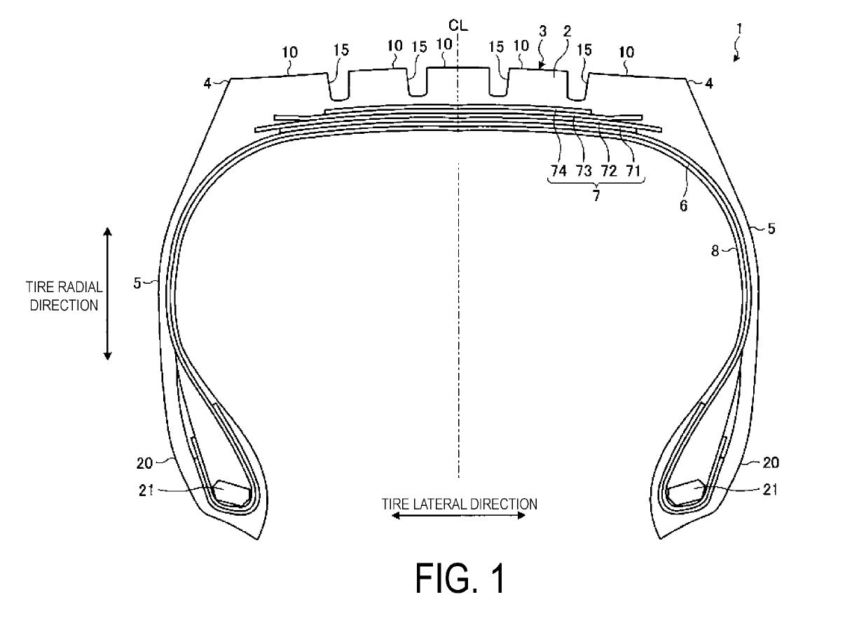

FIG. 1 is a meridian cross-sectional view illustrating a main portion of a pneumatic tire according to the present embodiment. “Meridian cross-section” refers to the cross section taken along the tire rotation axis.

The pneumatic tire 1 illustrated in FIG. 1, when viewed in the meridian cross-section, is provided with a tread portion 2 made of rubber material in the outermost portion in the tire radial direction. The surface of the tread portion 2, in other words the portion of the pneumatic tire 1 that comes into contact with the road surface during travel when the pneumatic tire 1 is mounted on a vehicle, is formed as a tread surface 3. A plurality of circumferential main grooves 15 extending continuously in the tire circumferential direction are formed in the tread surface 3 in the tire lateral direction. At least one circumferential main groove 15 is required to be formed in the tread surface 3. A plurality of land portions 10 are defined by the circumferential main grooves 15 in the tread surface 3. Note that the number, interval between, groove width, groove depth, and the like of the circumferential main grooves 15 are preferably set as appropriate. In other words, the tread pattern formed in the tread surface 3 is preferably set as appropriate.

The ends of the tread portion 2 in the tire lateral direction are formed as shoulder portions 4, and sidewall portions 5 are provided from the shoulder portions 4 to a predetermined position inward in the tire radial direction. In other words, the sidewall portions 5 are disposed in two places on either side of the pneumatic tire 1 in the tire lateral direction.

Furthermore, bead portions 20 are located inward of the sidewall portions 5 in the tire radial direction. The bead portions 20, in a similar manner to that of the sidewall portions 5, are disposed in two places on either side of the tire equatorial plane CL. In other words, the pair of bead portions 20 are disposed on either side of the tire equatorial plane CL in the tire lateral direction. The pair of bead portions 20 are each provided with a bead core 21. The bead core 21 is formed by winding a bead wire, which is a steel wire, into an annular shape.

The bead portions 20 are configured to be mountable on a 15° taper specified rim. Here, “specified rim” refers to an “applicable rim” as defined by the Japan Automobile Tyre Manufacturers Association (JATMA), a “Design Rim” as defined by the Tire and Rim Association (TRA), or a “Measuring Rim” as defined by the European Tyre and Rim Technical Organisation (ETRTO). In other words, the pneumatic tire 1 according to the present embodiment is mountable on a specified rim with portions where the bead portions 20 engage being inclined by an inclination angle of 15° with respect to the rotation axis.

A belt layer 7 is provided inward of the tread portion 2 in the tire radial direction. The belt layer 7, for example, has a multi-layer structure including four belts 71, 72, 73, 74. The belts 71, 72, 73, 74 are made by a process of covering a plurality of belt cords made of steel with a coating rubber and then a rolling process. The belts 71, 72, 73, 74 have an inclination angle with respect to the tire circumferential direction ranging from 15° to 70°, for example. At least one of the belts in the belt layer 7 is disposed with the direction of the belt cords intersecting that of the other belts. The belts 71, 72, 73, 74 function as reinforcing layers; and the second and third belts 72, 73 from the tire inner circumferential side have belt cords that intersect with each other, the first and second belts 71, 72 from the tire inner circumferential side have belt cords inclined in the same direction, and the third and fourth belts 73, 74 from the tire inner circumferential side have belt cords inclined in the same direction.

A radial ply carcass layer 6 is continuously provided inward of the belt layer 7 in the tire radial direction and inside the sidewall portions 5. The carcass layer 6 is supported by the pair of bead cores 21. The carcass layer 6 has a single layer structure made of one carcass ply and extends between the bead cores 21 disposed on either side in the tire lateral direction in a toroidal shape in the tire circumferential direction, forming the framework of the pneumatic tire 1. Specifically, the carcass layer 6 is disposed from one of the pair of bead portions 20 located on either side in the tire lateral direction to the other bead portion 20 and turned back at the bead portions 20 outward in the tire lateral direction along the bead cores 21 so as to wrap around the bead cores 21. In other words, the carcass layer 6 is disposed from inner side of the bead cores 21 in the tire lateral direction, passes the inner side of the bead cores 21 in the tire radial direction, and extends to the outer side of the bead cores 21 in the tire lateral direction, turning back around the bead cores 21 at the bead portions 20. The carcass ply of the carcass layer 6 disposed in such a manner is made by a process of covering a plurality of carcass cords made of steel with a coating rubber and then a rolling process.

Additionally, an innerliner 8 is formed along the carcass layer 6 on an inner side of the carcass layer 6 or on the side of the pneumatic tire 1 inward of the carcass layer 6. The innerliner 8 is the tire inner surface, i.e., the inner circumferential surface of the carcass layer 6, and reaches the lower portions or the bead toes of the bead cores 21 of the pair of bead portions 20 at both end portions in the tire lateral direction and extends in the tire circumferential direction in a toroidal shape. The innerliner 8 includes no cords as it is provided to suppress the permeation of air molecules to the tire outer side.

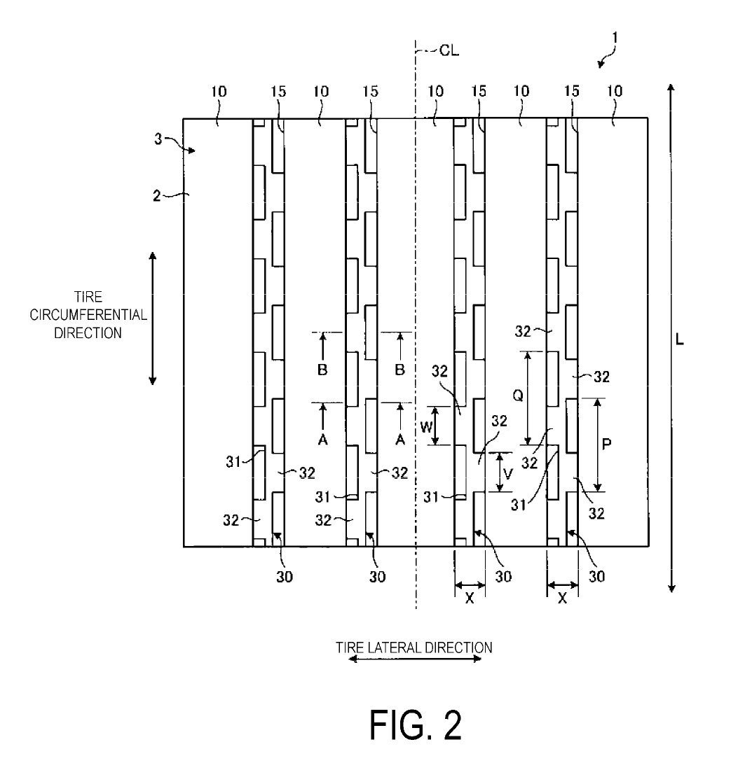

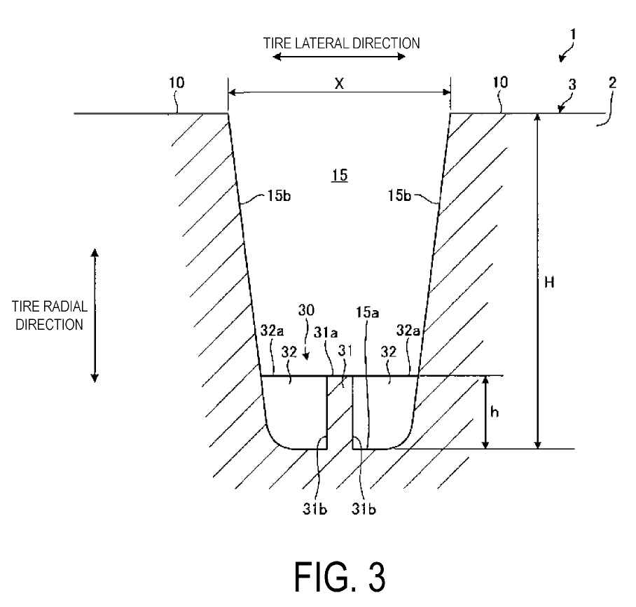

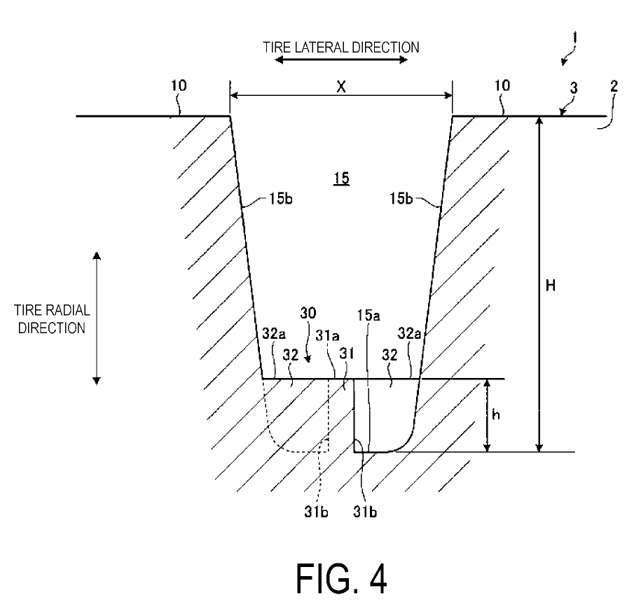

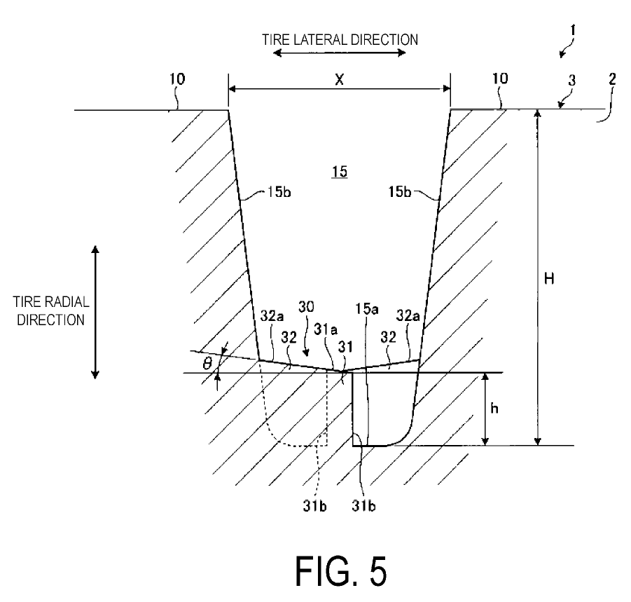

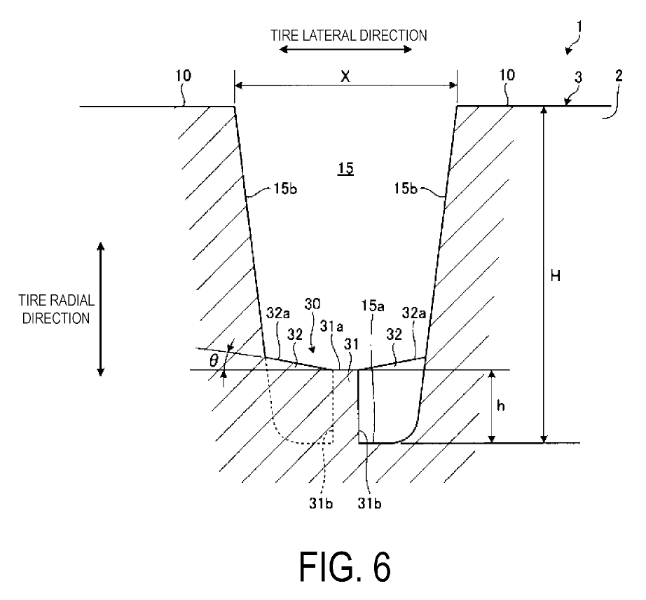

FIG. 2 is a plan view of a pneumatic tire according to the present embodiment. FIG. 3 is an enlarged cross-sectional view taken along line A-A illustrated in FIG. 2. FIG. 4 is an enlarged cross-sectional view taken along line B-B illustrated in FIG. 2. FIG. 5 is an enlarged cross-sectional view taken along line B-B of FIG. 2 of another embodiment. FIG. 6 is an enlarged cross-sectional view taken along line B-B of FIG. 2 of another embodiment.

As illustrated in FIGS. 2 to 4, the pneumatic tire 1 of the present embodiment includes a projection portion 30 made of a rubber material similar to that of the tread portion 2 in at least one of the circumferential main grooves 15. The projection portion 30 includes a projection body 31 that projects from a groove bottom 15a of the circumferential main groove 15, and connecting portions 32 that connect the projection body 31 to groove walls 15b of the circumferential main groove 15.

The projection body 31 projects from the groove bottom 15a of the circumferential main groove 15 outward in the tire radial direction. A projection end 31a is formed as a free end. Additionally, the projection body 31 is continuously formed in the extension direction of the circumferential main groove 15 (tire circumferential direction). Note that, although not illustrated in the drawings, the circumferential main groove 15 may extend in the tire circumferential direction in a curvilinear or zigzag manner in the tire lateral direction. In such an embodiment, the projection body 31 may conform to the shape of the circumferential main groove 15 and extend in a curvilinear or zigzag manner or may extend in the tire circumferential direction in a linear manner. Additionally, the projection end 31a of the projection body 31 may have a position in the tire radial direction that is constant or varies in the tire circumferential direction. The groove bottom 15a of the circumferential main groove 15 may have a position in the tire radial direction that is constant or varies in the tire circumferential direction.

The connecting portions 32 are formed connecting side surfaces 31b of the projection body 31 to the groove walls 15b of the circumferential main groove 15. The connecting portions 32 project from the groove bottom 15a of the circumferential main groove 15 outward in the tire radial direction and are provided continuously to the side surfaces 31b of the projection body 31 and the groove walls 15b of the circumferential main groove 15. As illustrated in FIGS. 3 to 6, ends 32a of the connecting portions 32 outward in the tire radial direction may reach the position of the end 31a of the projection body 31, or, although not illustrated in the drawings, may not reach the position of the end 31a of the projection body 31, stopping partway up the side surfaces 31b of the projection body 31.

Additionally, the connecting portions 32 are alternately disposed in the tire circumferential direction on either side of the projection body 31 in the tire lateral direction. Thus, the connecting portions 32 include one connected to the side surface 31b on a first side of the projection body 31 in the tire lateral direction and one connected to the side surface 31b on a second side of the projection body 31 in the tire lateral direction. Furthermore, by the connecting portions 32 being alternately disposed in the tire circumferential direction, the number of the connecting portions 32 connected to the side surface 31b on the first side of the projection body 31 in the tire lateral direction and the connecting portions 32 connected to the side surface 31b on the second side of the projection body 31 in the tire lateral direction are the same. As illustrated in FIG. 2, the connecting portions 32 may be alternately disposed without the connecting portions 32 on either side of the projection body 31 in the tire lateral direction overlapping one another in the tire circumferential direction. Alternatively, although not illustrated in drawings, the connecting portions 32 on either side of the projection body 31 in the tire lateral direction may partially overlap in the tire circumferential direction.

In such a configuration of the pneumatic tire 1 of the embodiment, Relationship (1) below is satisfied, where L is the circumferential length of the projection body 31, V₁ to Vₙ are the circumferential dimensions of the connecting portion 32 disposed on the first side of the projection body 31 in the tire lateral direction, and W₁ to Wₙ are circumferential dimensions of the connecting portions 32 disposed on the second side of the projection body 31 in the tire lateral direction.

$$0.7 L \leq {\sum }_{k = 1}^{n} ( {V}_{k} + {W}_{k} ) ≦ 1.5 L \qquad ( 1 )$$

The circumferential length L of the projection body 31 indicates the linear length in the tire circumferential direction as viewed in a plan view measured at the position of the end 31a of the projection body 31. Thus, even if the projection body 31 has a curvilinear or zigzag shape in the tire lateral direction, the circumferential length L is the same. Additionally, in embodiments in which the end 31a of the projection body 31 varies in position in the tire radial direction, the circumferential length L of the projection body 31 is measured using the innermost position of the end 31a in the tire radial direction as a reference. Furthermore, the circumferential dimensions V, W of the connecting portions 32 are circumferential dimensions of the ends 32a located outward in the tire radial direction. For example, in an embodiment in which the connecting portions 32 widen in the tire circumferential direction, and the circumferential dimensions of the ends 32a located outward in the tire radial direction are difference from the circumferential dimensions at the groove bottoms 15a, the circumferential dimensions V, W of the connecting portions 32 are the circumferential dimensions of the ends 32a located outward in the tire radial direction. Additionally, in an embodiment in which the edges in the tire circumferential direction of the ends 32a located outward in the tire radial direction are chamfered or radiused, the circumferential dimensions V, W of the connecting portions 32 are measured using the intersection points between extensions of the surface of the ends 32a of the connecting portions 32 and the side surfaces of the connecting portions 32 in the tire circumferential direction as a reference.

According to the pneumatic tire 1 of the present embodiment, the relationship represented by Relationship (1) between the circumferential length L of the projection body 31 and the circumferential dimensions V, W of the connecting portions 32 ranges from 0.7 L to 1.5 L. This allows the rigidity of the projection body 31 to be appropriately set and anti-stone drilling performance to be improved. In other words, when the relationship between the circumferential length L of the projection body 31 and the total of the circumferential dimensions V, W of the connecting portions 32 is 0.7 L or greater, the rigidity of the projection body 31 is appropriately set and the projection body 31 is resistance to collapsing in the tire lateral direction, thus preventing stone entrapment. This improves anti-stone drilling performance. When the relationship between the circumferential length L of the projection body 31 and the total of the circumferential dimensions V, W of the connecting portions 32 is greater than 1.5 L, the connecting portion 32 buries most of the groove bottom 15a of the circumferential main groove 15. This reduces drainage performance and reduces the uneven wear resistance performance of the tread surface 3 due to the high rigidity of the land portions 10 defined by the circumferential main grooves 15. As a result, according to the pneumatic tire 1 of the present embodiment, anti-stone drilling performance can be further improved.

Note that to further improve anti-stone drilling performance and suppress a decrease in the drainage performance and uneven wear resistance performance of the circumferential main grooves 15, the relationship represented by Relationship (1) between the circumferential length L of the projection body 31 and the circumferential dimensions V, W of the connecting portions 32 preferably has a lower limit and upper limit of 0.9 L or greater and L or less.

In the pneumatic tire 1 of the present embodiment, the circumferential main groove 15 provided with the projection portion 30 (the projection body 31 and the connecting portions 32) is preferably disposed on at least the tire equator line CL or closest to the tire equator line CL.

The circumferential main groove 15 on the tire equator line CL or closest to the tire equator line CL bulges outward in the tire radial direction due to the crown shape of the tread surface 3. This makes it susceptible to stone entrapment. Thus, by providing the projection portion 30 (the projection body 31 and the connecting portions 32) in this circumferential main groove 15, stone entrapment can be prevented. This allows a significant effect of improving anti-stone drilling performance to be obtained. Note that the projection portion 30 (the projection body 31 and the connecting portions 32) can be provided in all of the circumferential main grooves 15 to improve the anti-stone drilling performance of all of the circumferential main grooves 15.

As illustrated in FIG. 2, in the pneumatic tire 1 of the present embodiment, the relationship between the circumferential dimensions V of a discretionary connecting portion 32 disposed on the first side of the projection body 31 in the tire lateral direction and a groove width X of the circumferential main groove 15 preferably satisfies 0.5X≤V≤5X. The relationship between the circumferential dimensions W of a discretionary connecting portion 32 disposed on the second side of the projection body 31 in the tire lateral direction and the groove width X of the circumferential main groove 15 preferably satisfies 0.5X≤W≤5X.

As illustrated in FIGS. 3 to 6, the groove width X of the circumferential main groove 15 is the lateral dimensions of the circumferential main groove 15 at the opening portion to the tread surface 3. Additionally, the groove width X of the circumferential main groove 15 is constant in the tire circumferential direction and continuously unchanging in the tire circumferential direction. Furthermore, in an embodiment in which the opening edges of the circumferential main groove 15 at the tread surface 3 are chamfered or radiused, the groove width X is measured using the intersection points between extensions of the tread surface 3 and the surface of the groove wall 15b of the circumferential main groove 15 as a reference.

According to the pneumatic tire 1, by the circumferential dimensions V, W of the connecting portions 32 ranging from 0.5 times to 5 times the groove width X of the circumferential main groove 15, the rigidity of the connecting portion 32 is appropriately set, and the change in the groove bottom 15a of the circumferential main groove 15 formed by the connecting portions 32 is appropriately set. This allows a significant effect of improving anti-stone drilling performance to be obtained. When the circumferential dimensions V, W of the connecting portions 32 are 0.5 times or greater than the groove width X of the circumferential main groove 15, the effect of improving the rigidity of the connecting portions 32 can be obtained. When the circumferential dimensions V, W of the connecting portions 32 are 5 times or less than the groove width X of the circumferential main groove 15, the change in the groove bottom 15a of the circumferential main groove 15 formed by the connecting portions 32 is maintained and the same cross section continuing in the tire circumferential direction is prevented. This allows stone ejecting characteristics to be ensured.

As illustrated in FIG. 2, in the pneumatic tire 1 of the present embodiment, the relationship between a circumferential pitch P between a discretionary adjacent pair of the connecting portions 32 disposed on the first side of the projection body 31 in the tire lateral direction and the groove width X of the circumferential main groove 15 preferably satisfies X≤P≤3X. The relationship between a circumferential pitch Q between a discretionary adjacent pair of the connecting portions 32 disposed on the second side of the projection body 31 in the tire lateral direction and the groove width X of the circumferential main groove 15 preferably satisfies X≤Q≤3X.

According to the pneumatic tire 1, by the circumferential pitches P, Q of the connecting portions 32 ranging from 1 time to 3 times the groove width X of the circumferential main groove 15, the rigidity of the projection body 31 and the connecting portions 32 are appropriately set. This allows a significant effect of improving anti-stone drilling performance to be obtained. When the circumferential pitches P, Q of the connecting portion 32 are at least 1 times the groove width X of the circumferential main groove 15, the circumferential dimensions V, W of the connecting portions 32 are maintained and a decrease in the rigidity of the connecting portions 32 is suppressed. As a result, stone ejecting characteristics can be ensured. When the circumferential pitches P, Q of the connecting portions 32 are 3 times or less than the groove width X of the circumferential main groove 15, the distance between the connecting portions 32 is appropriate maintained. This allows the effect of improving the rigidity of the projection body 31 to be obtained.

When the circumferential dimensions V, W of the connecting portions 32 ranges from 0.5 times to 5 times the groove width X of the circumferential main groove 15 (0.5X≤V≤5X, 0.5X≤W≤5X), the circumferential pitches P, Q of the connecting portions 32 preferably range from 0.6 times to 10 times the groove width X of the circumferential main groove 15 (0.6X≤P≤10X, 0.6X≤Q≤10X). This allows the circumferential dimensions V, W of the connecting portions 32 and the circumferential pitches P, Q of the connecting portions 32 to be appropriately set with respect to the groove width X of the circumferential main groove 15. As a result, a significant effect of improving anti-stone drilling performance can be obtained.

As illustrated in FIGS. 3 to 6, in the pneumatic tire 1 of the present embodiment, the relationship between groove depth (radial dimensions) H of the circumferential main groove 15 and height (radial dimensions) h of the projection body 31 preferably satisfies 0.05H≤h≤0.5H.

In an embodiment in which the groove depth H of the circumferential main groove 15 varies in the tire circumferential direction, the groove depth H of the circumferential main groove 15 is the depth of the circumferential main groove 15 at a position where the groove bottom 15a is furthest from the tread surface 3. Additionally, in an embodiment in which the height from the groove bottom 15a of the projection body 31 varies, the height h of the projection body 31 is the height at a position closest to the groove bottom 15a of the circumferential main groove 15.

According to the pneumatic tire 1, by specifying the height h of the projection body 31 in relation to the groove depth H of the circumferential main groove 15, a significant effect of improving anti-stone drilling performance can be obtained. By the height h of the projection body 31 being 0.05 times or greater the groove depth H of the circumferential main groove 15, a significant effect of preventing stone entrapment can be obtained. By the height h of the projection body 31 being 0.5 time or less the groove depth H of the circumferential main groove 15, the projection body 31 is resistant to collapsing in the tire lateral direction when stones are trapped.

As illustrated in FIGS. 5 and 6, in the pneumatic tire 1 of the present embodiment, the connecting portions 32 are preferably inclined outward in the tire radial direction with respect to the tire lateral direction from the projection body 31 toward the groove walls 15b of the circumferential main groove 15 and have an inclination angle θ ranging from 15° to 45°.

As illustrated in FIG. 5, the inclination of the connecting portions 32 may include the end 31a of the projection body 31, or, as illustrated in FIG. 6, the inclination may not include the end 31a of the projection body 31.

According to the pneumatic tire 1, by specifying the inclination angle θ of the connecting portions 32, stones can be prevented from being trapped in the circumferential main grooves 15 and stone ejecting characteristics are improved. As a result, a significant effect of improving anti-stone drilling performance can be obtained. When the inclination angle θ of the connecting portions 32 is 15° or greater, stones can be prevented from being caught above the connecting portions 32 and stone entrapment can be suppressed. When the inclination angle θ of the connecting portions 32 is 45° or less, a force for pushing the stone outside (toward the opening) of the circumferential main groove 15 rather than a force for drawing the stone to the groove wall 15b opposite to the connecting portion 32 works. This allows stone ejecting characteristics to be improved.

### EXAMPLES

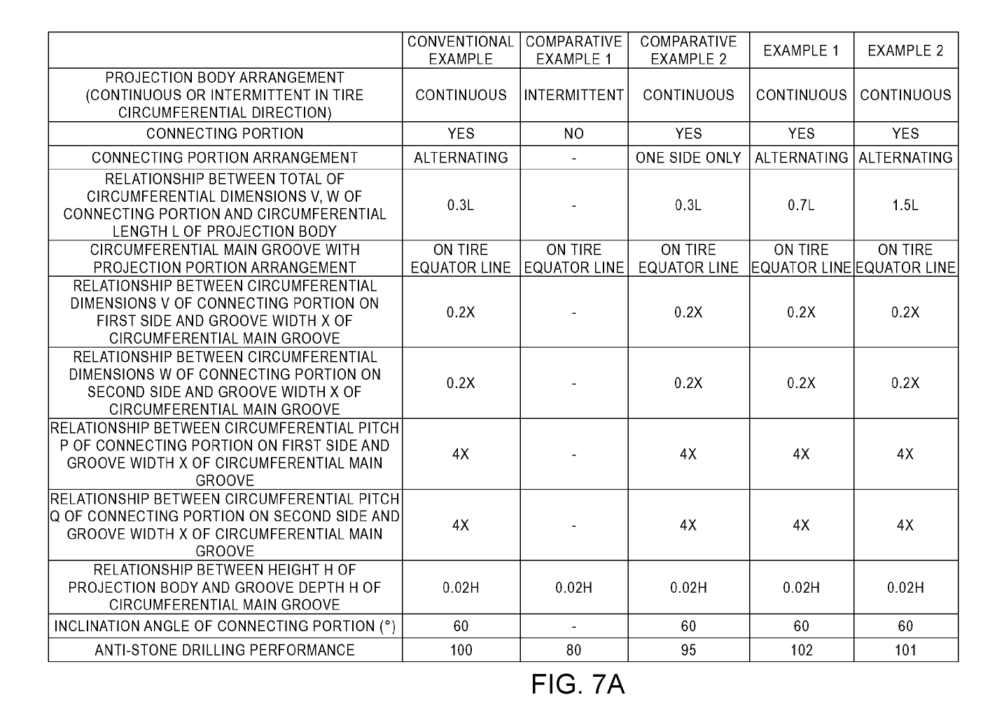

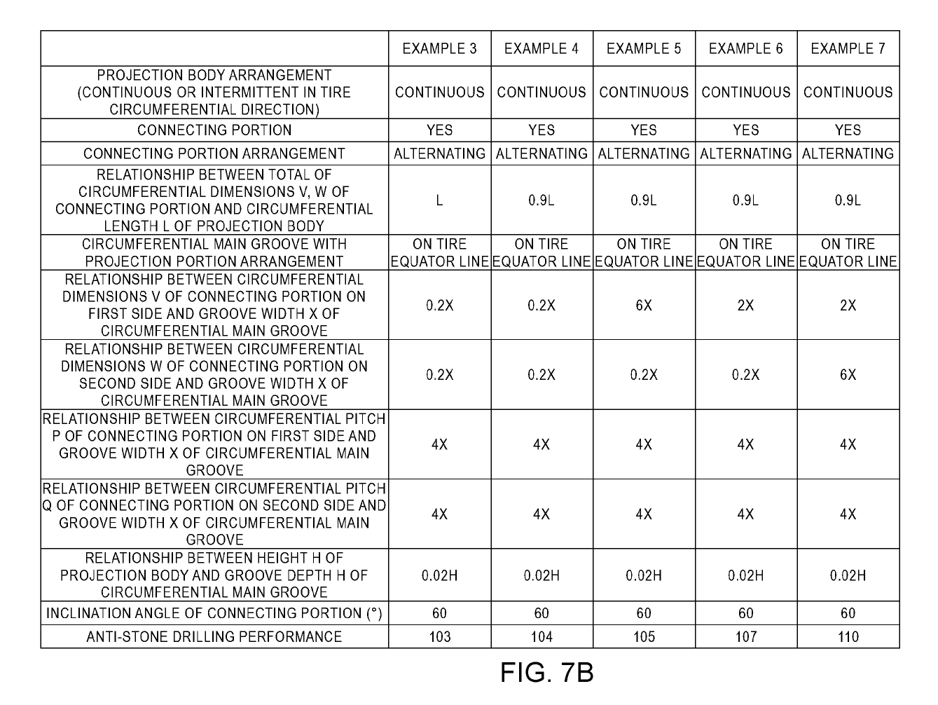

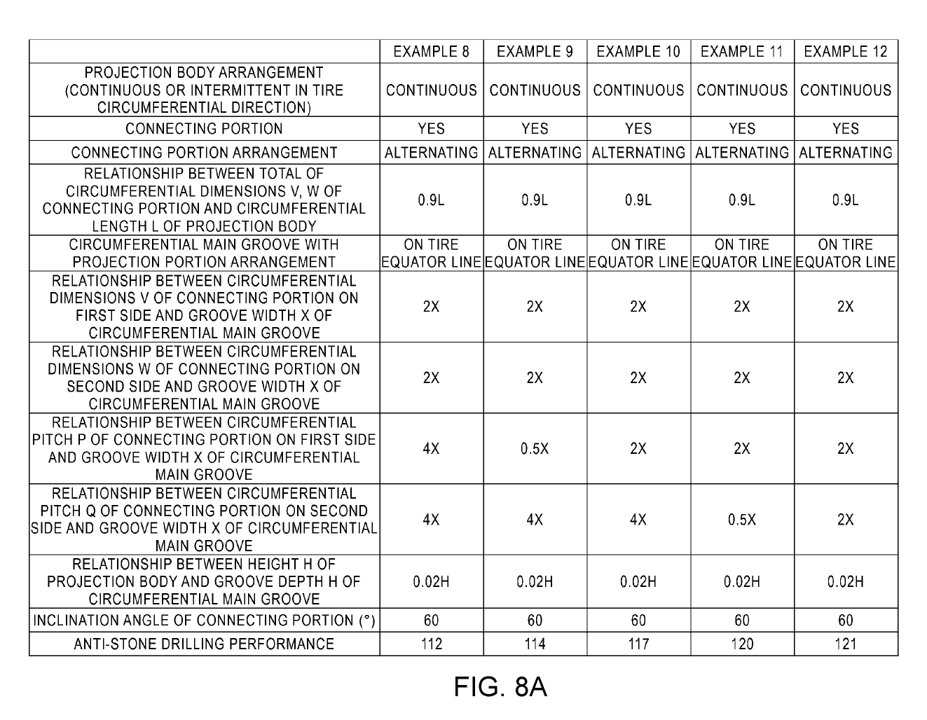

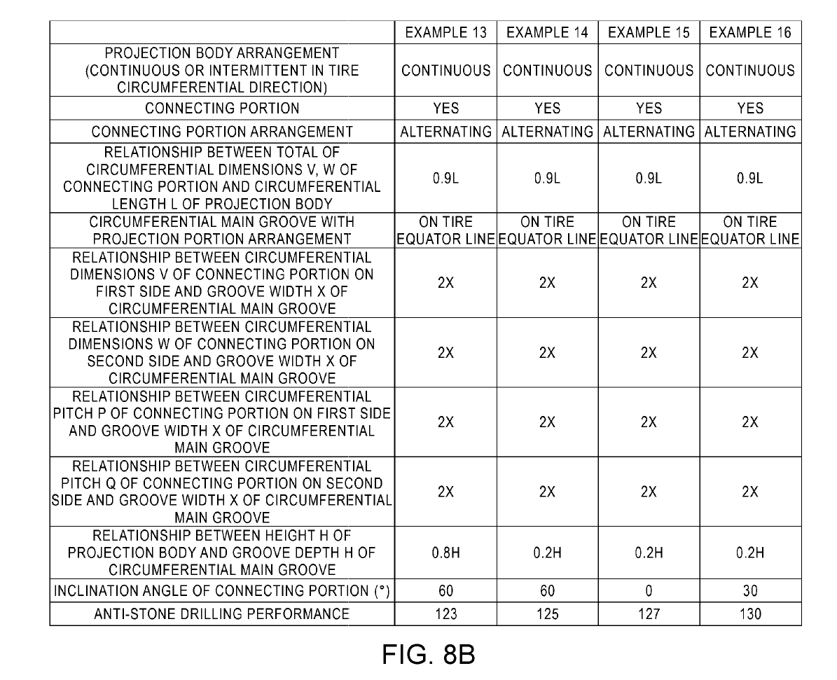

In the Examples, performance tests for anti-stone drilling performance were performed on a plurality of types of pneumatic tires of different conditions (see FIGS. 7A-7B and 8A-8B).

In these performance tests, pneumatic tires (heavy duty pneumatic tires) having a tire size of 295/75R22.5 were mounted on specified rims, inflated to a specified air pressure, and mounted on a test vehicle (2-D, 4 wheels).

Here, “specified rim” refers to an “applicable rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organisation (ETRTO). “Specified air pressure” refers to “maximum air pressure” defined by JATMA, a maximum value given in “TIRE LOAD LIMITS AT VARIOUS COLD INFLATION PRESSURES” defined by TRA, or “INFLATION PRESSURES” defined by ETRTO.

For evaluation of anti-stone drilling performance, the test vehicle was driven on a 2 km course in a stone pit for ten laps at 20 km/h. Thereafter, the number of stones that reached the groove bottom of the circumferential main grooves was measured. Evaluation was carried out by expressing the measurement results as index values with the results of the Conventional Example being defined as the reference (100). In this evaluation, larger values indicate a smaller number of stones that reaches the groove bottom of the circumferential main grooves and superior anti-stone drilling performance.

As shown in FIGS. 7A-7B and 8A-8B, the projection body and the connecting portion for Conventional Example, Comparative Example 1, and Comparative Example 2 are not set with the specified parameters. The projection body and the connecting portion of Examples 1 to 16 are set with the specified parameters.

As can be seen from the test results of FIGS. 7A-7B and 8A-8B, the pneumatic tires of Examples 1 to 16 have enhanced anti-stone drilling performance.

1. A pneumatic tire, comprising:
a tread surface of a tread portion comprising
at least one circumferential main groove extending continuously in a tire circumferential direction;
a projection body extending continuously in the tire circumferential direction and projecting in a tire radial direction from a groove bottom of the at least one circumferential main groove; and
connecting portions alternately disposed in the tire circumferential direction on a first side and a second side of the projection body in a tire lateral direction, the connecting portions connecting the projection body and groove walls of the at least one circumferential main groove;
the relationship represented by relationship (1) being satisfied, where L is a circumferential length of the projection body, V₁ to Vₙ are circumferential dimensions of the connecting portions disposed on the first side of the projection body in the tire lateral direction, and W₁ to Wₙ are circumferential dimensions of the connecting portions disposed on the second side of the projection body in the tire lateral direction;
$$0.7 L ≦ {\sum }_{k = 1}^{n} ( {V}_{k} + {W}_{k} ) ≦ 1.5 L \qquad ( 1 )$$

2. The pneumatic tire according to claim 1, wherein the at least one circumferential main groove provided with the projection body and the connecting portions is disposed at least on a tire equator line or closest to the tire equator line.

3. The pneumatic tire according to claim 2, wherein
the relationship 0.5X≤V≤5X is satisfied, where V is the circumferential dimensions of a discretionary connecting portion of the connecting portions disposed on the first side of the projection body in the tire lateral direction, and X is a groove width of the at least one circumferential main groove; and
the relationship 0.5X≤W≤5X is satisfied, where W is the circumferential dimensions of a discretionary connecting portion of the connecting portions disposed on the second side of the projection body in the tire lateral direction, and X is the groove width of the at least one circumferential main groove.

4. The pneumatic tire according to claim 2, wherein
the relationship X≤P≤3X is satisfied, where P is a circumferential pitch of a discretionary adjacent pair of the connecting portions disposed on the first side of the projection body in the tire lateral direction, and X is the groove width of the at least one circumferential main groove; and
the relationship X≤Q≤3X is satisfied, where Q is a circumferential pitch of a discretionary adjacent pair of the connecting portions disposed on the second side of the projection body in the tire lateral direction, and X is the groove width of the at least one circumferential main groove.

5. The pneumatic tire according to claim 4, wherein the relationship 0.05H≤h≤0.5H is satisfied, where H is a groove depth of the at least one circumferential main groove and h is a height of the projection body.

6. The pneumatic tire according to claim 5, wherein the connecting portions are inclined outward in the tire radial direction with respect to the tire lateral direction from the projection body toward the groove walls of the at least one circumferential main groove and have an inclination angle ranging from 15° to 45°.

7. The pneumatic tire according to claim 1, wherein
the relationship 0.5X≤V≤5X is satisfied, where V is the circumferential dimensions of a discretionary connecting portion of the connecting portions disposed on the first side of the projection body in the tire lateral direction, and X is a groove width of the at least one circumferential main groove; and
the relationship 0.5X≤W≤5X is satisfied, where W is the circumferential dimensions of a discretionary connecting portion of the connecting portions disposed on the second side of the projection body in the tire lateral direction, and X is the groove width of the at least one circumferential main groove.

8. The pneumatic tire according to claim 1, wherein
the relationship X≤P≤3X is satisfied, where P is a circumferential pitch of a discretionary adjacent pair of the connecting portions disposed on the first side of the projection body in the tire lateral direction, and X is the groove width of the at least one circumferential main groove; and
the relationship X≤Q≤3X is satisfied, where Q is a circumferential pitch of a discretionary adjacent pair of the connecting portions disposed on the second side of the projection body in the tire lateral direction, and X is the groove width of the at least one circumferential main groove.

9. The pneumatic tire according to claim 1, wherein the relationship 0.05H≤h≤0.5H is satisfied, where H is a groove depth of the at least one circumferential main groove and h is a height of the projection body.

10. The pneumatic tire according to claim 1, wherein the connecting portions are inclined outward in the tire radial direction with respect to the tire lateral direction from the projection body toward the groove walls of the at least one circumferential main groove and have an inclination angle ranging from 15° to 45°.
